(19) United States
(12) Patent Application Publication
(10) Pub. No.: US 2014/0320422 A1
(43) Pub. Date: Oct. 30, 2014

(54) TOUCH-SENSITIVE PANEL FOR A COMMUNICATION DEVICE

(71) Applicants: GEORGIA TECH RESEARCH COPORATION, ATLANTA, GA (US); MOTOROLA SOLUTIONS, INC, SCHAUMBURG, IL (US)

(72) Inventors: William R. Williams, Coral Springs, FL (US); Bo Feng, Atlanta, GA (US); George P. Peterson, Atlanta, GA (US)

(21) Appl. No.: 13/871,611

(22) Filed: Apr. 26, 2013

(51) Int. Cl. G06F 3/041

(52) U.S. Cl. CPC G06F 3/041
USPC 345/173

(57) ABSTRACT

An improved touch-sensitive panel is provided. The improved touch-sensitive panel comprises ALD alumina coated on hard glass which allows the touch screen to operate when wet without false actuations while maintaining a hard, transparent, scratch resistant hydrophilic surface.

### FIELD OF THE INVENTION

The present invention relates generally to touch-sensitive panels and more particularly to a scratch resistant, transparent, and hydrophilic touch-sensitive panel for a communication device.

### BACKGROUND

Many of today's consumer communication devices incorporate a touch-sensitive panel as part of a user interface. For example, projected capacitive (PCAP) touch screens are widely used on portable electronic devices such as smart phones and tablets. One recurring performance issue with PCAP touch screens is that a drop of water will inadvertently actuate the device. This actuation arises because the capacitance signature of a “tall” drop of water closely mimics a finger, and the touch screen will falsely register this as a touch.

FIG. 1A shows a cross sectional diagram of a touch-sensitive panel 100, such as a PCAP touch screen, comprising a y-electrode layer 104, an x-electrode layer 106, and a touch surface 108. In response to the touch screen being energized, electric fields 110 are formed between the x and y electrode layers. FIG. 1B shows how the charge gets projected 130 in response to a user's finger 120 touching the touch screen. When the user's finger 120 comes into contact with the touch surface 108, it steals charge from the x-electrode 106 thereby changing the capacitance between electrodes by projecting the electric field lines 130 beyond the touch screen surface 108. FIG. 1C shows how a charge gets projected 150 in response to a water droplet 140 touching the touch surface 108. Much of the charge 150 is stolen from the x-electrode 106, in a manner very similar to a finger both in surface area and change in capacitance. The water droplet 140 tends to remain spherical and is difficult to differentiate from a finger, thereby causing false actuations. The touch-sensitive panel 100 is said to have a hydrophobic surface which is one which tends to keep a water droplet spherical.

In today's handheld consumer market, the majority of PCAP touch screen cell phones and tablets have a hydrophobic surface on the lens with contact angles falling typically in the range of 80-120 degrees. Hydrophobic coatings are used in these types of products because the hardness and scratch resistant properties are considered desirable. An example of a hydrophobic coating is an anti-glare coating disposed on the lens of most cell phones and tablets. However, most of these devices tend to false, and occasionally lock up, with a single drop of water rolling around on the touch screen.

While some commercially available plastic lens protectors exhibit marginal hydrophilic tendencies (contact angle less than or equal to thirty degrees), false actuations, also referred to as falsing, are still not entirely eliminated. Also, plastic lens protectors tend to be soft and are easily scratched making them unsuitable candidates for devices used in harsh or rugged environments, such as the public safety environment.

When seeking to incorporate a PCAP touch screen on a communication device, such as portable handheld radio, the false actuation problem is exacerbated due to the fact that these products tend to be utilized under harsher wet environmental conditions. For example, portable radios that are operated in fire rescue environments, or even paramedic and law enforcement, can face particularly wet or rainy conditions. Touch screens tend not to be used in such devices because of the need to meet Public Safety rain specifications. The ability to distinguish between a finger and a water drop is thus highly important in this public safety market.

Accordingly, there is a need for a touch-sensitive panel that allows a communication device to operate properly when wet.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIGS. 1A, 1B and 1C illustrate a cross sectional diagram of a touch screen in accordance with the prior art.

FIGS. 2A, 2B and 2C illustrate a cross sectional diagram of a touch sensitive panel formed in accordance with the various embodiments.

FIG. 3A illustrates a contact angle for a typical hydrophobic touch screen.

FIG. 3B illustrates a contact angle for a hydrophilic touch sensitive panel coated with ALD alumina in accordance with the various embodiments.

FIG. 5 is an operational diagram of a touch-sensitive panel formed and operating in accordance with the various embodiments.

FIG. 6A illustrates water droplets on an uncoated microscope slide of regular glass.

FIG. 6B is illustrates water droplets on a microscope slide having ALD alumina coated thereon in accordance with the various embodiments.

FIG. 6C is a photograph of water droplets on an uncoated microscope slide made of regular glass.

FIG. 6D is a photograph of water droplets on a microscope slide having ALD alumina coated thereon in accordance with the various embodiments.

FIGS. 7A, 7B, and 7C illustrate a comparison of water droplets falling on different types of coated glass versus uncoated glass in accordance with the various embodiments.

FIGS. 8A, 8B, 8C, and 8D show comparison photos of scratch test results for various surfaces in accordance with the various embodiments.

FIG. 9A shows an IR touch screen having operating in accordance with the various embodiments.

FIG. 9B shows a cross sectional diagram of an IR touch with an uncoated surface.

FIG. 9C shows a cross sectional diagram of an IR touch screen having a coating of ALD alumina deposited thereon in accordance with the various embodiments.

FIG. 10 is a communication device comprising a touch-sensitive panel formed in accordance with the various embodiments.

FIG. 11 is a flowchart for adding a surface coating to a touch screen in accordance with the various embodiments.

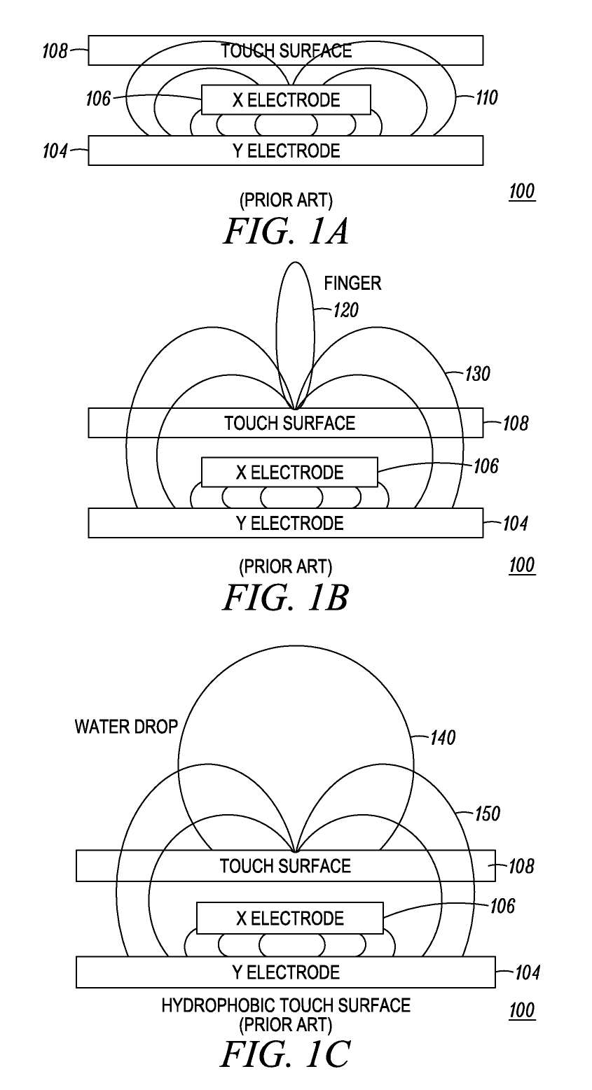

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in a touch-sensitive panel for a communication device. The touch-sensitive panel, formed in accordance with the various embodiments, continues to operate even when the communication device is operated under wet conditions. Accordingly, the components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

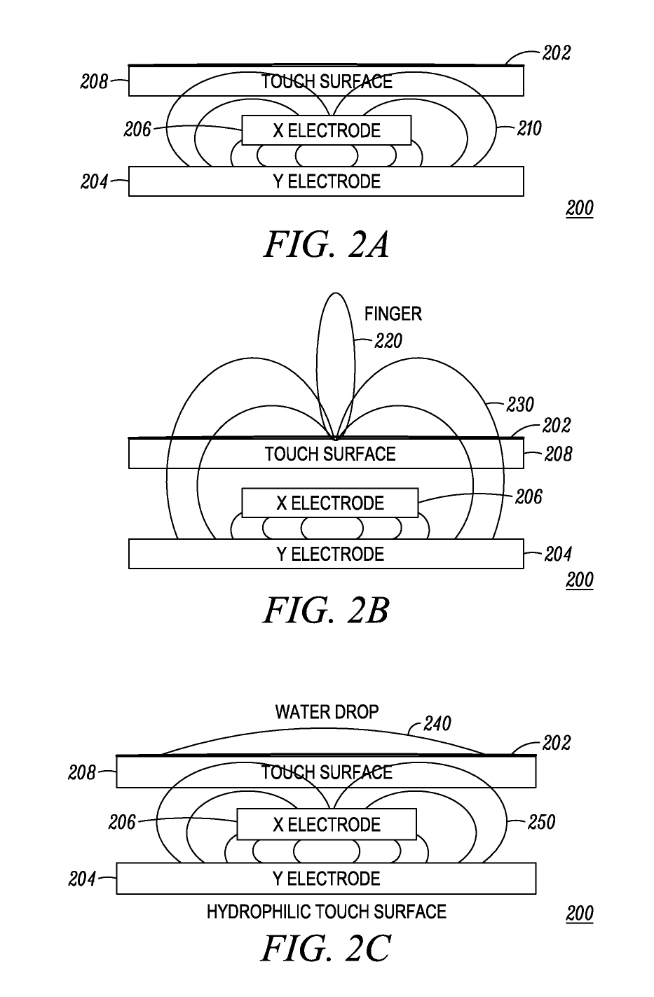

FIGS. 2A, 2B and 2C illustrate cross sectional diagrams of a touch-sensitive panel 200 formed in accordance with the various embodiments. The touch-sensitive panel 200 formed in accordance with the various embodiments provides a touch surface with hydrophilic properties which eliminates false actuations.

Studies by the innovators indicate the conditions under which false actuations can occur, and the conditions under which false actuations can be eliminated. Several phones and tablets with PCAP touch screens were tested with water drops both as-delivered and modified to have about a 15 degree contact angle; iPhone 4, 4s, 5 and iPad from Apple, Droid Razr, Razr Maxx and ET-1 Tablet from Motorola, Galaxy from Samsung and Droid DNA from HTC. All the devices were easily falsed with a water drop as-delivered, and none could be falsed once the screen was modified to have about a 15 degree contact angle. To create the contact angle, tape was placed over the glass, and then coated with an anti-fog coating. The devices were tested under both tape-only conditions and tape with anti-fog coating conditions. All of the devices falsed after the tape was added, but none of the devices falsed after the anti fog coating was added. However, there are currently no available PCAP touch screens with this type of contact angle that are hard and scratch resistant.

In accordance with the various embodiments, a touch-sensitive panel comprising a PCAP touch screen has been developed to provide a contact angle of less than or equal to 20 degrees that is also hard and scratch resistant. Other touch-sensitive panels will also be discussed in later embodiments including an infrared (IR) touch screen.

Referring to FIG. 2A, the touch-sensitive panel 200 comprises a PCAP touch screen formed of a y-electrode layer 204, an x-electrode layer 206, and a touch surface 208. In response to the touch-sensitive panel 200 being energized, electric fields 210 are formed between the x and y electrode layers. In accordance with the various embodiments, the touch-sensitive panel 200 comprises an ALD alumina coating 202 applied thereon.

FIG. 2B, shows how the charge gets projected 230 in response to a user's finger 220 touching the touch-sensitive panel 200. When the user's finger 120 comes into contact with the touch surface 208, it steals charge from the x-electrode 206 thereby changing the capacitance between electrodes by projecting the electric field lines 230 beyond the touch screen surface 208.

Referring to FIG. 2C, there is shown a water drop 240 hitting the hydrophilic touch surface 208. Since the height of the water drop 240 is kept “low” the projected capacitance measurement does not change as much as with a finger. In accordance with the various embodiments, the ALD alumina coating 202 provides a hydrophilic surface for water droplets 240 hitting the surface to disperse and form a low profile contact angle of less than 20 degrees. The hydrophilic surface provided by the ALD coating 202 is resistant to water droplets thereby minimizing false entries to the touch-sensitive panel 200. Additionally, the ALD alumina coating 202 applied to the touch-surface 208 provides a transparency and hardness for scratch resistance for touch-sensitive panel 200.

In accordance with the various embodiments, the ALD alumina coating 202 has a predetermined thickness range over which the contact angle is maintained at less than 20 degrees. The predetermined thickness of the ALD alumina coating 202 can range between 40 nm to 100 nm with no substantial change in the contact angle; increasing the thickness beyond 100 nm adds cost (processing time) with no hydrophilic or scratch resistance benefit, while decreasing transmittance. In accordance with the various embodiments, the touch-sensitive panel 200 may further be a textured touch-sensitive panel to provide anti reflective/anti glare properties without the use of an anti reflective additional coating.

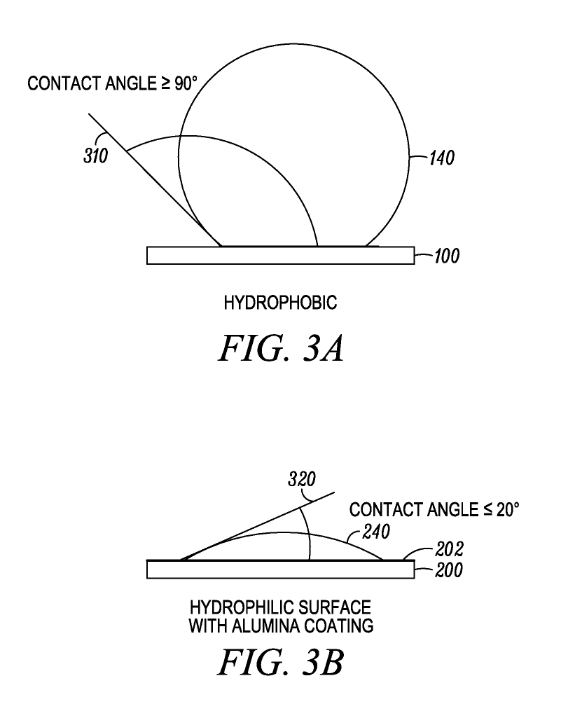

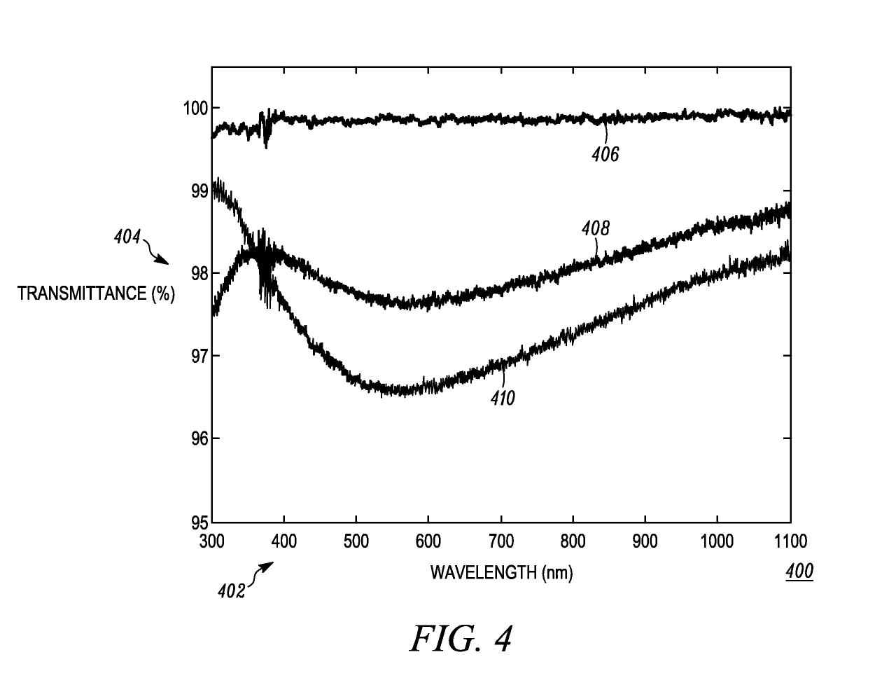

FIG. 3A illustrates a contact angle for the typical hydrophobic touch screen 100. The water droplet 140 on the hydrophobic touch screen 100 of FIG. 3A tends to have a contact angle 310 of greater than or equal to ninety degrees. FIG. 3B illustrates a contact angle 320 for the touch sensitive panel 200 coated with ALD alumina 202 in accordance with the various embodiments. In accordance with the various embodiments, the touch-sensitive panel 200 comprising an ALD alumina coating 202 applied thereto provides a hydrophilic surface which disperses the water droplet 240 over a predetermined maximum contact angle of less than or equal to 20 degrees. The thickness of the ALD alumina coating 202 can vary between 40 nm to 100 nm while maintaining the contact angle. The ALD alumina coating 202 adds the further provides a hard, scratch resistant surface capable of operating under harsh environments.

In accordance with the various embodiments, the touch-sensitive panel 200 utilizes nano material, such as alumina nano coatings, prepared using atomic layer deposition at relatively low temperature (approximately 100 degrees C.) using trimethyl aluminum (TMA) and de-ionized water vapor in a vacuum chamber. For example, a 40 ms pulse of TMA and a 100 ms pulse of water vapor at a pressure of 1 Torr produces a dense uniform alumina layer. In accordance with testing results using X-Ray Diffraction, the deposited alumina coating exhibits an amorphous structure, as opposed to a single crystalline structure. The optical transmittance of samples has measured higher than 96 percent in the range of ultra violet, visible and infra red (wavelength of 300-1100 nm). The static contact angle was smaller than 7 degrees at room temperature. A scratch test of 100 swipes with steel wool (1 lb weight) showed the surface to be highly scratch resistant.

FIG. 4 is a graph 400 of transmittance (percentage) 404 relative to wavelength (nm) 402 for uncoated glass 406, glass coated with a thickness of 40 nm of ALD alumina and glass coated with a thickness of 100 nm of ALD alumina This data was measured with a GE 4300 pro UV-Vis spectrophotometer. The UV-Vis spectra measured greater than 96 percent for 100 nm of ALD alumina coating. Hence, the ALD alumina coating provides very good transparency well suited to the touch surface of a touch-sensitive panel.

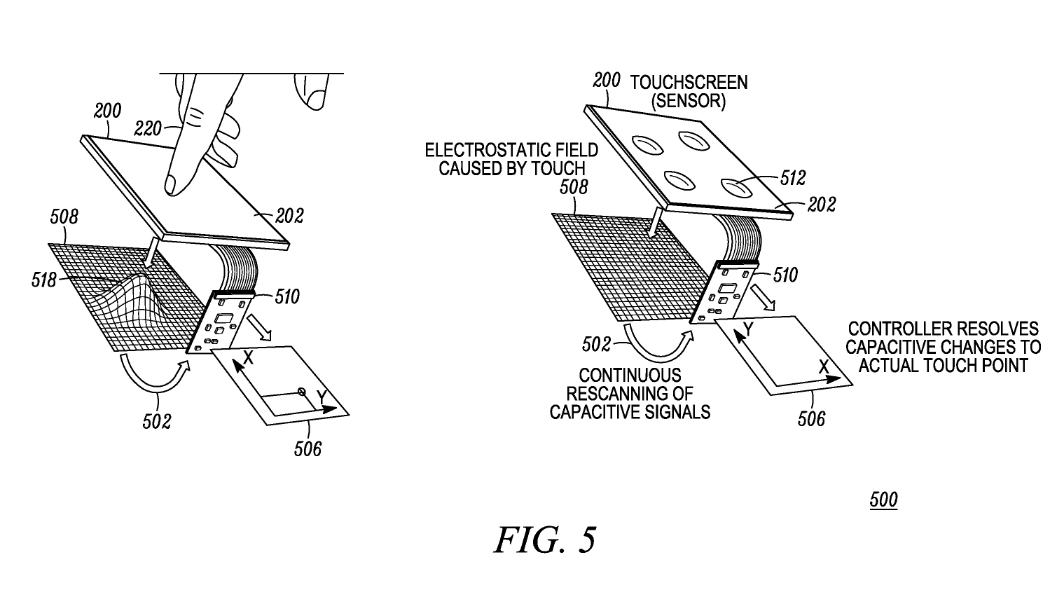

FIG. 5 is an operational diagram of a touch-sensitive panel, such as touch-sensitive panel 200, formed and operating with firmware 500 in accordance with the various embodiments. The touch-sensitive panel 200 comprises the ALD coating layer 202 in accordance with the embodiments. Firmware 500 including controller board 510 provides continuous rescanning of capacitive signal 502 to generate coordinates 506. The controller board 510 resolves capacitive changes to actual touch points on the panel 200. When a user's finger 220 touches panel 200, the sensors of the panel sense a disturbance 518 in electrostatic field 508 caused by the touch of the finger. In accordance with the various embodiments, when water droplets 512 touch panel 200, the droplets disperse and thin out to a contact angle of less than or equal to 20 degrees. The sensors of the panel 200 thus sense an undisturbed electrostatic field 508. Thus, a hydrophilic, transparent, and scratch resistant hard touch-sensitive panel has been provided. The additional benefits of good adhesion and anti-tarnish are also provided.

The touch-sensitive panel 200 formed in accordance with the various embodiments allows water droplets to quickly spread and dissipate, significantly reducing their thickness (contact angle ≦20°). In accordance with the various embodiments, with this contact angle, the capacitance signature is significantly different than a “tall” drop of water, and is no longer falsely interpreted as a finger actuation by the touch-sensitive panel firmware. In accordance with the various embodiments, the atomic layer deposition (ALD) process may be used to deposit the alumina on glass. The alumina material and ALD process add a hard, transparent, scratch resistant hydrophilic surface coating to the touch surface of a touch-sensitive panel 200.

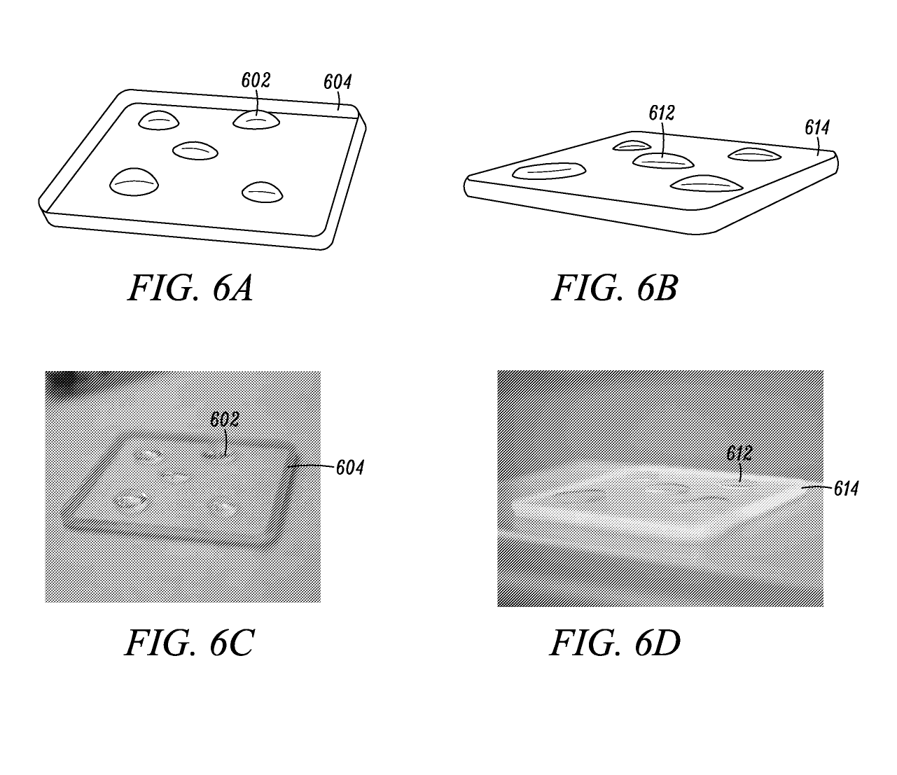

FIGS. 6A, 6B, 6C and 6D show illustrations and photos comparing water droplets on uncoated glass to glass coated with ALD alumina in accordance with the various embodiments. FIG. 6A illustrates water droplets 602 on an uncoated microscope slide of regular glass 604, and FIG. 6C is an actual photograph of the water droplets 602 on an uncoated microscope slide made of regular glass 604. The water droplets 602 are spherical in shape on the uncoated glass 604. FIG. 6B illustrates water droplets 612 on a microscope slide having ALD alumina coated thereon 614, and FIG. 6D is a photograph of water droplets 612 on a microscope slide having ALD alumina coated thereon 614 in accordance with the various embodiments. As seen in FIGS. 6B and 6D, the water droplets 612 on the ALD coated glass 614 are flatter and have a lower contact angle than those on uncoated glass. Uncoated glass has an average contact angle of about 35 degrees, whereas to achieve a consistent “works when wet”, the contact angle, in accordance with the various embodiments, needs to be less than or equal to 20 degrees.

The ALD alumina coating provides a clear, scratch resistant hydrophilic surface that can be used on a touch-sensitive panel, such as a PCAP touch screen or IR touch screen. The use of a single layer ALD provides an improved touch-sensitive panel with all the desirable properties, most notably the “works when wet” property.

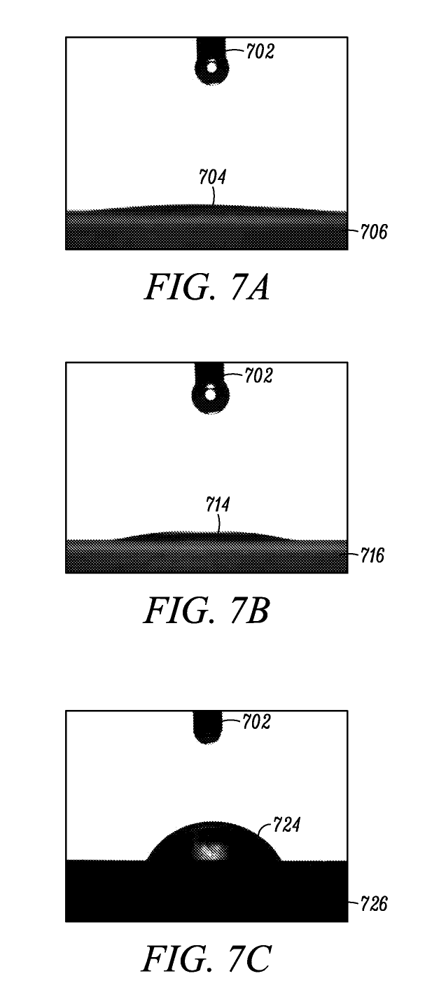

FIGS. 7A, 7B, and 7C shows photographs comparing water contact angles for water droplets dispensed by a dispenser 702 on different types of coated glass. Each photograph was taken by a Ramé-Hart machine for angle measurement. FIG. 7A is a photograph of water droplet 704 dispersed on hard glass coated by thermal ALD alumina 706. The dispersed water droplet 704 measured a water contact angle of 6.9 degrees on the ALD coated hard glass 706. For the photo taken in FIG. 7A, the hard glass selected was Gorilla glass, available from Corning, coated by thermal ALD alumina The thickness of the ALD alumina coating in FIG. 7A was 100 nm.

Gorilla Glass is a registered trademark for an alkali-aluminosilicate sheet glass manufactured by U.S. glassmaker Corning. Engineered for a combination of thinness, lightness, and damage-resistance, it is used primarily as the cover glass for portable electronic devices including mobile phones, portable media players, laptop computer displays, and some television screens. The glass material's primary properties are its strength (allowing thin glass without fragility), high scratch resistance (protective coating), and hardness rating. Other hard glass is also available in the market, such as Xensation Cover Glass, a break and scratch-resistant alumino-silicate manufactured by Schott. The examples of glass are not intended to be limiting as other suitable hard glass is also available.

FIG. 7B shows dispersed water droplet 714 that measured a water contact angle of 7.4 degrees on Gorilla glass coated by thermal ALD alumina 716. The thickness of the ALD alumina coating in FIG. 7B was 50 nm.

FIG. 7C shows a photo of water droplet 724 on a hydrogen fluoride (HF) treated silicon wafer 726. This surface produced a water contact angle measuring 61.9 degrees. FIG. 7C is provided to show how the lack of the ALD alumina coating resulted in a spherical shaped water droplet which would cause false actuations on a touch-sensitive panel, as compared to FIGS. 7A and 7B which would not cause false actuations. These measurements support that even a thin layer of ALD alumina coating on a hard glass is sufficient to disperse a water droplet.

While the embodiments have been described in terms of glass material, the alumina coating may also be used on plastic for suitable applications. Putting an alumina coating on to a plastic lens using an ALD process will provide a hard surface finish on the plastic that will resist surface scratches. Hence, the glass touch screen lens would be well suited for high tier public safety products, such as first responder and mission critical radios needing to meet very robust standards, and a plastic touch screen lens would be suitable for a lower tier product. Non-conducting glass or plastic material having sufficient optical clarity and dielectric constant is suitable for the touch-screen panel of the various embodiments. A touch-sensitive panel with a glass touch surface having a transmittance of 96% and a dielectric constant ranging from 3.8-14.5 coated with ALD alumina is well suited to a public safety communication device.

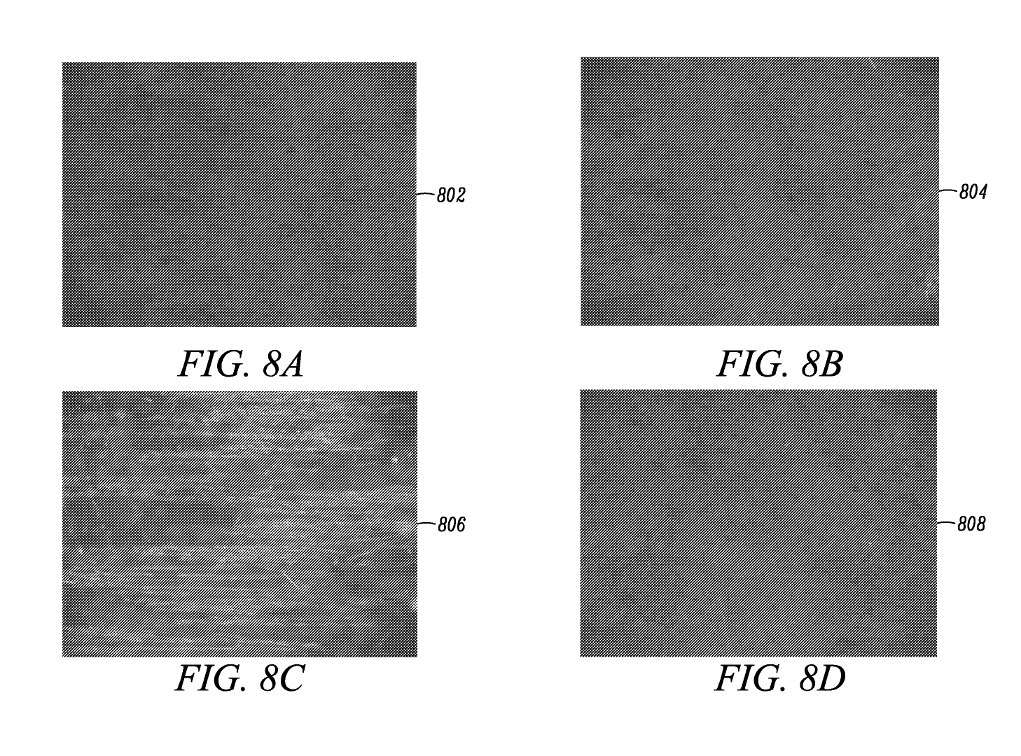

FIGS. 8A, 8B, 8C, and 7D show comparisons of photos of scratch test results on various surfaces. Testing conditions included a 1 lb weight on #0000 steel wool being swiped over the surface 100 times. Photos were taken with identical zoom (16×) and lighting conditions. FIG. 8A shows a photo of uncoated Gorilla glass 802. FIG. 8B shows a photo of uncoated Gorilla glass 804 after being scratch tested. FIG. 8C shows a photo of Lotus Leaf coated Gorilla glass 806 after being scratch tested. Lotus Leaf produces a commercially available super hydrophilic coating that creates a water contact angle of less than 5 degrees when applied to glass. However, as seen in FIG. 8C, this type of coating did not provide the scratch resistant properties provided by the ALD coated glass. FIG. 8D shows a photo of ALD coated Gorilla glass 808 after scratch tested. As shown by FIG. 8D, (being similar to FIG. 8A and FIG. 8B) the surface formed in accordance with the various embodiments having an ALD coating has proven to be highly scratch resistant.

The properties used when analyzing glass and coatings include such parameters as contact angle, thickness, heat resistance, UV exposure, optical clarity and haze. The following Table (Table 1) provides a list comparing the properties for various types of glass and coatings.

TABLE 1

| Type of | | | | | |
|---|---|---|---|---|---|
| Coating on | | | | | |
| 2 mm thick | Trans- | | | Scratch | |
| Gorilla Glass | mittance | Contact Angle | | Performance | Comments |
| Gorilla Glass | 100% | Approx. | degrees | Good | |
| Non coated | | 35 | | | |
| TiO2 | 72% | <25 | degrees | Not Tested | Requires UV |
| Lotus Leaf | 96% | <5 | degrees | Poor | |
| Alumina | 96% | <10 | degrees | Good | |
| ALD | | | | | |

Testing has shown that ALD alumina coatings have been able to produce contact angles of less than 20 degrees with a thickness of 100 nm or less. The clarity of ALD alumina is good, and its resistance to scratch and heat is excellent. To maintain the contact angle, and particularly for products operating in a ruggedized environment, a touch-sensitive panel having an ALD alumina coating thickness of between 40 nm to 100 nm provides good clarity and scratch resistance.

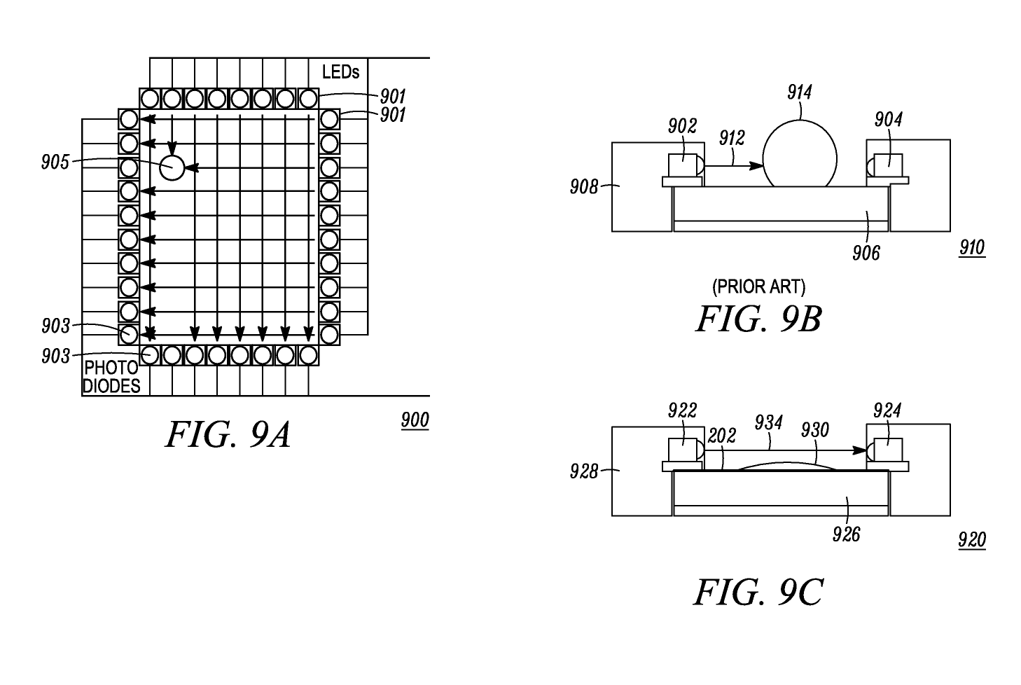

As mentioned previously, the touch-sensitive panel may be formed of a PCAP touch screen or an IR touch screen. FIG. 9A shows an IR touch screen 900 having a touch area surrounded by LEDs 901 and photo diodes 903 forming a touch area grid. A touch entry 905 is registered by interrupting a light path from the LEDs 901 towards the photo diodes 903. FIG. 9B shows a cross sectional diagram of an IR touch screen surrounded by a bezel 908 containing LEDs 902 and photo diodes 904. The hydrophobic surface of the touch screen 906 causes a water droplet 914 on touch surface 906 to retain its tall spherical shape. The spherical shape of water droplet 914 interrupts light path 912, resulting in a false actuation. The only way to potentially circumvent the problem would be to increase the height of the bezel 908 to move the LEDs up higher than the water drop 914. However, this would significantly grow the size of the area and not be suitable for most types of handheld products.

FIG. 9C shows an IR touch screen 326 having a coating of ALD alumina 202 deposited thereon in accordance with the various embodiments. The IR touch screen formed in accordance with the various embodiments provides a hydrophilic surface and is seated within a bezel 928 containing LEDs 922 and photo diodes 924. A water droplet 920 on the touch surface of the ALD alumina coated IR touch screen 326 flattens to a contact angle of less than 20 degrees thereby avoiding any interruption to light path 934. The hydrophilic surface creates a short water drop, and does not block light path thereby allowing for a shorter bezel. Thus, the ALD alumina coating may be applied to different types of touch-sensitive panels, such as IR touch screens and PCAP touch screens to provide a hydrophilic surface that thins our and disperses water droplets to an angle of less than or equal to 20 degrees thereby avoiding false actuations.

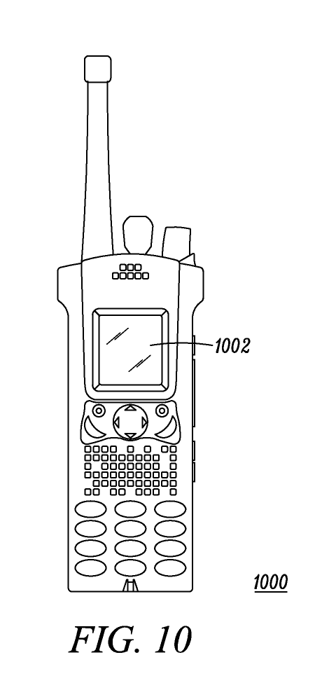

FIG. 10 shows a communication device, such as a portable handheld two-way radio 1000, incorporating a touch-sensitive panel 1002 formed in accordance with the various embodiments. The touch-sensitive panel 1002 comprises a hydrophilic surface for spreading water droplet profiles to a predetermined contact angle upon contact. In accordance with the various embodiments, the hydrophilic surface is provided by the addition an ALD alumina layer disposed on the touch-sensitive panel. The radio 1000 comprises a controller, operatively coupled to touch-sensitive panel 1002, for example the controller board of FIG. 5.

The touch-sensitive panel 1002 may comprise a touch-screen display (optically clear) or a touch pad (optically opaque), utilizing PCAP or infrared (IR) touch technologies. Thus, the radio 1000 may comprise a PCAP touch screen, a PCAP touch pad, an infrared (IR) touch screen, an infrared (IR) touch pad, or other touch-sensitive panel or panel technology. Any touch-sensitive panel having a surface which tends incur false actuations from water droplets can benefit from the touch-sensitive panel formed in accordance with the various embodiments.

In accordance with the various embodiments, the alumina material provides a hard, transparent, scratch resistant hydrophilic surface coating to the touch surface of the touch-sensitive panel 1002, thereby causing water droplets to quickly spread and dissipate, and significantly reducing their thickness (contact angle ≦20°). The hydrophilic surface being resistant to water droplets minimizes false entries to the touch-sensitive panel. Thus, a scratch resistant, “work when wet” radio has been provided. The touch-sensitive panel 1002 may be textured, if desired, to provide increased hydrophilicity and anti-reflection and anti glare without the use of an additional anti-reflective coating.

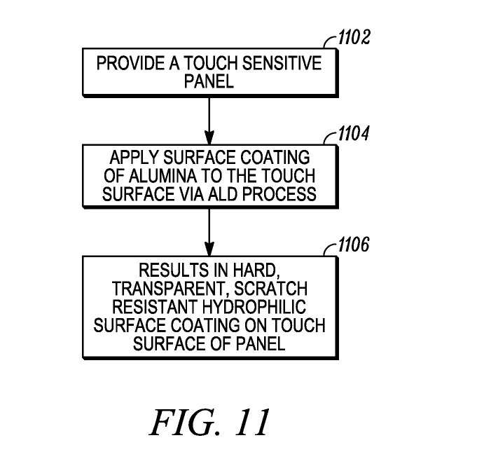

FIG. 11 is a flowchart for a method 1100 of forming a touch-sensitive panel in accordance with the various embodiments. Beginning at 1102 a touch-sensitive panel, such as a PCAP screen, IR touch pad, or the like is provided. Applying a surface coating of alumina to the panel via an ALD process at 1104, results in an ALD alumina coating which provides a hard, transparent, scratch resistant, hydrophilic surface coating to the touch surface of the panel. Deposition systems such as those available from Cambridge Nanotech can be used to generate thin films one atomic layer at a time and are thus suitable to be used to generate the coated glass of the various embodiments. Other deposition systems may also be utilized.

Although a layer as thin as 10 nm can be used to form the hydrophilic surface, a single layer having a thickness of between 40 nm-100 nm ensures that the contact angle remains at less than or equal to 20 degrees. The method 1100 thus provides the advantages of a single step single layer approach. In accordance with the various embodiments, anti-reflection performance can be achieved without adding an anti-reflection coating, by texturing the surface of the touch screen (use textured glass or plastic) such that the ALD alumina is put on top of the textured surface. Unlike anti reflective/anti glare coatings used on touch screens today is hydrophobic, thus making all the screens are hydrophobic. The ALD alumina coating may be applied to the touch-sensitive panel using a single step coating process absent of a first layer of nanoparticles. The single layer ALD process is a good way to produce a PCAP touch screen with the desired properties of hardness and scratch resistance, and most notably the “works when wet” property.

Accordingly, there has been provided in accordance with the various embodiments, an improved touch-sensitive panel. Various touch-sensitive panels, such as PCAP touch screens and IR touch pads and others that can be falsed with tall water drops can benefit from the various embodiments. The improved touch-sensitive panel comprising ALD alumina coated on hard glass allows the touch screen to “work when wet” without false actuations while maintaining a hard, transparent, scratch resistant hydrophilic surface. The touch-sensitive panel having an ALD layer is thus highly suitable for products operating in the public safety market.

Unlike systems that utilize silica nanoparticle suspension (liquid based) that is UV cured, the touch-sensitive screen formed with ALD (precursor gas based) hydrophilic coating provides the advantages of an anti-scratch type hard coating for glass or plastics along with anti fog (directly related to its hydrophilic properties) and anti-static effects. The ALD coating layer can also be used as a “primer”, because it sticks well to many surfaces and many subsequent coatings can easily stick to it. No adhesive layers are required.

Further advantages include low temperature synthesis which is compatible to most engineering plastic and glass materials, ease of deposition on any pre-cleaned surface with no significant degradation in performance.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A communication device, comprising:
a touch-sensitive panel; and
an atomic layer deposition (ALD) alumina coating applied to the touch-sensitive panel, the ALD alumina coating providing a hydrophilic surface for water droplets hitting the surface to disperse and form a low profile contact angle of less than 20 degrees.

2. The communication device of claim 1, wherein the hydrophilic surface resistant to water droplets minimizes false entries to the touch-sensitive panel.

3. The communication device of claim 1, wherein the touch-sensitive panel with ALD alumina coating applied thereto provides a transparency and hardness for scratch resistance.

4. The communication device of claim 1, without anti-reflective thin film coating.

5. The communication device of claim 1, wherein the touch-sensitive panel is textured.

6. The communication device of claim 5, wherein textured touch-sensitive panel provides increased hydrophilicity and further provides anti-reflection and anti glare without the use of an additional coating.

7. The communication device of claim 1, wherein the touch-sensitive panel comprises a touch pad.

8. The communication device of claim 7, wherein the touch pad comprises an infrared (IR) touch pad or projective capacitive (PCAP) touch pad.

9. The communication device of claim 8, wherein the IR touch pad is surrounded by a bezel.

10. The communication device of claim 1, wherein the touch-sensitive panel comprises a touch-screen display.

11. The communication device of claim 10, wherein the touch-screen display comprises a projective capacitive (PCAP) screen or an infrared (IR) touch screen.

12. The communication device of claim 1, wherein the communication device comprises a portable handheld radio.

13. The communication device of claim 1, wherein the ALD alumina coating comprises a single coating.

14. A two-way radio, comprising:
a touch-sensitive panel having a hydrophilic surface for spreading water droplet profiles to a predetermined contact angle upon contact.

15. The two-way radio of claim 14, wherein the hydrophilic surface comprises an ALD alumina coating applied to the touch-sensitive panel, the ALD alumina coating having a predetermined thickness range over which the contact angle is maintained at less than 20 degrees.

16. The two-way radio of claim 15, wherein the ALD alumina coating provides transparency and hardness for scratch resistance.

17. The two-way radio of claim 14, wherein the predetermined thickness of the ALD alumina coating is between 40 nm to 100 nm with no substantial change in the contact angle.

18. The two-way radio of claim 14, wherein the touch-sensitive panel is a textured touch-sensitive panel to provide anti reflective and anti glare properties without the use of an additional coating.

19. A touch-sensitive panel, comprising:
an ALD alumina coating applied to the touch-sensitive panel, the ALD alumina coating providing a hydrophilic surface for dispersing water droplets over a predetermined maximum contact angle.

20. The touch-sensitive panel wherein the predetermined maximum contact angle is less than 20 degrees.

21. The touch-sensitive panel of claim 19, wherein the dispersement of water droplets over a predetermined maximum contact angle of 20 degrees minimizes false touch inputs to the touch-sensitive panel.

22. The touch-sensitive panel of claim 19, wherein the single layer ALD alumina coating provides a works when wet property to a PCAP touch screen.

23. The touch-sensitive panel of claim 19, wherein the ALD alumina coating comprises a single layer coating absent a first layer of nanoparticles.
